(19) United States
(12) Patent Application Publication
(10) Pub. No.: US 2018/0237258 A1
(43) Pub. Date: Aug. 23, 2018

(54) Elevator System

(71) Applicant: Otis Elevator Company, Farmington, CT (US)

(72) Inventor: Peter Herkel, Berlin (DE)

(21) Appl. No.: 15/508,745

(22) PCT Filed: Sep. 10, 2014
(86) PCT No.: PCT/EP2014/069285

§ 371 Date: Mar. 3, 2017

(51) Int. Cl. B66B 1/34; B66B 5/00

(52) U.S. Cl. CPC B66B 1/3461; B66B 5/0012; B66B 1/3453

(57) ABSTRACT

An elevator system (1) comprises: an elevator car (4), which is moveable along a hoistway (2); a mobile node (8) moving with the elevator car (4); a stationary node (14), which does not move with the elevator car (4); and a CAN-bus (60) interconnecting the mobile node (8) with the stationary node (14) for transmitting data between the nodes (8, 14). The mobile node (8) and the stationary node (14) are configured for transmitting sound and/or video data from and/or to the elevator car (4) via the CAN-bus (60).

The invention is related to an elevator system, in particular to an elevator system including a communication system allowing vocal and/or visual communication between passengers situated in an elevator car and people which are situated outside the elevator car, e.g. in an external service center.

### State of the Art

In an elevator system, e.g. during maintenance or in emergency situations, in particular when people are trapped in an elevator car, there is a desire to allow communication between people situated within or on the elevator car and people which are located spaced apart from the elevator car, in particular people situated at or in the hoistway, in the machine room of the elevator or in an external service center.

Currently there are two widely used alternatives for implementing a communication system in an elevator system:

According to a first alternative, an alarm device is provided at the car. The alarm device is connected by four wires provided in a traveling cable comprising a stationary end and a mobile end traveling with the elevator car; two wires for the telephone line and two for the intercom system. In a second alternative the alarm device is provided in the controller with ten wires provided in the traveling cable for connecting an alarm button, a microphone, a loudspeaker, an intercom, and alarm indicators. Due to use of analogue transmission technique, the quality of the voice communication can be very low, which might cause misunderstanding.

Thus, there is a desire to improve the vocal communication between people situated in or on an elevator car and people which are situated outside the elevator car.

### DISCLOSURE OF THE INVENTION

According to an exemplary embodiment of the invention an elevator system comprises an elevator car which is moveable along a hoistway; a mobile node moving together with the elevator car; a stationary node, which does not move with the elevator car, and a CAN-bus (“Controller Area Network-bus”) interconnecting the mobile node with the stationary node for transmitting data between the nodes. The mobile node and the stationary node are configured for transmitting sound data, in particular voice data, and/or video data, from and/or to the elevator car via the CAN-bus.

A method of transmitting sound data, in particular voice data, and/or video data from and to an elevator car according to an exemplary embodiment of the invention comprises the steps of:
converting the sound and/or video data into digital data;
transmitting the digital data via a CAN-bus from and/or to the elevator car;
converting the digital data into sound and/or video.

An exemplary embodiment of the invention will be described in the following with reference to the enclosed figures.

The figures and the following discussion describe particular embodiments of the invention so as to teach those skilled in the art how to produce and use the best modes of the invention. In order to teach the principle of the invention, several conventional aspects have been simplified or omitted. Those skilled in the art should understand that variations originating from these embodiments also fall within the scope of the invention. Those skilled in the art should understand that the features to be described below can be combined in various ways so as to form numerous variations of the invention. Therefore, the invention is not limited to the following particular embodiments and is merely defined by the appended claims and their equivalents.

### SHORT DESCRIPTION OF THE FIGURES

FIG. 1 shows a schematic view of an elevator system according to an exemplary embodiment of the invention.

FIG. 2 shows an enlarged schematic view of the traveling cable extending between the stationary node and the mobile node of an elevator system according to an exemplary embodiment of the invention.

### DESCRIPTION OF THE FIGURES

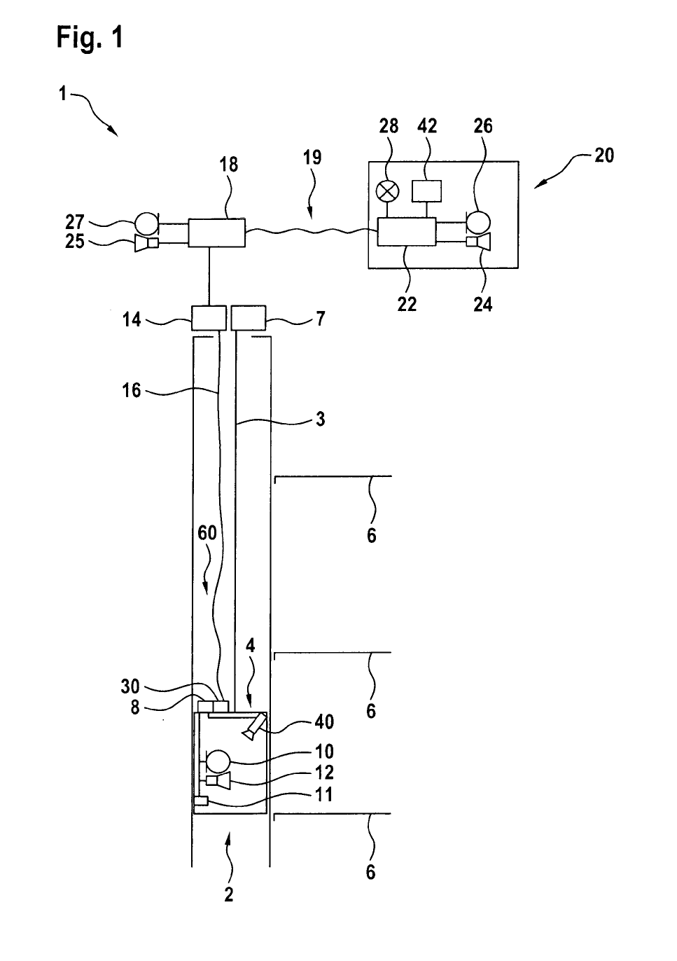

FIG. 1 shows a schematic view of an elevator system 1 according to an exemplary embodiment of the invention.

The elevator system 1 comprises a hoistway 2 extending in a vertical direction between a plurality of floors 6, and an elevator car 4, which is suspended by means of a tension member 3 in order to be moved in a vertical direction between the different floors 6 by means of an elevator drive 7. The tension member 3 and the elevator drive 7 forming the elevator's drive system are shown only schematically, as their details are not relevant for the present invention. The drive system in particular may comprise a counterweight, which is not shown in FIG. 1.

The elevator car 4 is provided with a control electronic 30 for controlling the elevator car 4 and a mobile node 8, which is electrically connected to a mobile microphone 10, a mobile loudspeaker 12 and an alarm button 11 provided inside the elevator car 4.

The control electronic 30 and the mobile node 8 are electrically connected to a stationary node 14, which is provided outside the elevator car 4 at or near the hoistway 2 and which does not move together with the elevator car 4, by means of an electric cable (“traveling cable”) 16 extending basically parallel to the tension member 3 along the height of the hoistway 2. The traveling cable 16 comprises a plurality of wires including wires providing a CAN-bus 60 which allows to transmit digital data between the mobile node 8 and the stationary node 14.

In the embodiment shown in FIG. 1, the stationary node 14 is located on top of the hoistway 2 next to the elevator drive 7. In alternative embodiments, which are not shown in the figures, the stationary node 14 may be provided at the bottom of the hoistway 2 or at any position between the bottom and the top of the hoistway 2, in particular at one of the plurality of floors 6.

The stationary node 14 is functionally connected to an auto-dialer 18 enabling the stationary node 14 to establish a connection with an external service center 20 via an external network 19, e.g. a common telephone line, for exchanging messages, in particular alarm and/or maintenance messages, between the stationary node 14 and the service center 20.

In order to allow vocal communication between people situated in/at the elevator car 4 and the personnel of the service center 20, a communication unit 22, a stationary loudspeaker 24 and a stationary microphone 26 are provided at the service center 20.

Alternatively or additionally, a stationary loudspeaker 25 and/or a stationary microphone 27, which are respectively connected to the stationary node 14, may be provided close to the hoistway 2, e.g. in the machine room (not shown) of the elevator system 1, in order to allow vocal communication between passengers located in the elevator car 4 and service personal being present at the hoistway 2.

In case of emergency or failure of the elevator system 1, a passenger situated in the elevator car 4 may push the alarm button 11 in order to trigger an alarm.

When the alarm button 11 is pushed, an alarm message is transmitted from the mobile node 8 via the CAN-bus 60 comprised in the traveling cable 16 to the stationary node 14 causing the auto-dialer 18 to establish a connection between the stationary node 14 and the service center 20 in order to send an alarm message to the service center 20, which might cause an emergency light 28 to light up.

Additionally, an audio connection is established between the elevator car 4 and the service center 20 allowing passengers situated in the elevator car 4 to communicate with a person in the service center 20 by means of the mobile microphone 10 and the mobile loudspeaker 12 connected to the mobile node 8 and the stationary loudspeaker 24 and the stationary microphone 26, which are connected to the communication unit 22 in the service center 20.

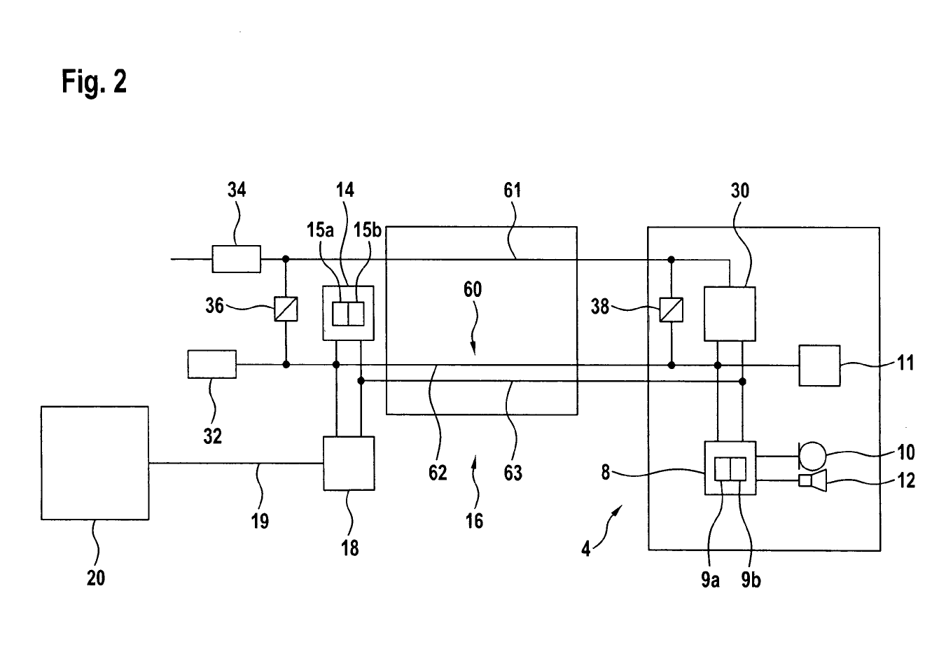

Analog audio signals provided by the microphones 12, 26 are respectively converted into digital data by analog/digital converters 9a, 15a, which are respectively provided in the mobile node 8 and the stationary node 14 (see FIG. 2), and the digital data is transferred to the other node 14, 8 via the CAN-bus 60, which is provided by the traveling cable 16. A digital/analog-converter 9b, 15b in the receiving node 8, 14 (see FIG. 2) converts the received digital data into analogue audio signals, which are then fed to the respective loudspeaker 12, 24 for is reproducing the respective sound.

The elevator car 4 additionally may be equipped with at least one video camera 40, and a video display 42 may be provided in the service center 20. In this case video information may be transmitted from the elevator car 4 to the service center 20 additionally or alternatively to the audio information. An additional video camera in the service center 20 and a video display in the elevator car 4, which are not shown in the figures, may be provided in order to allow the transmission of video data from the service center 20 to the elevator car 4.

By transferring digital audio and potentially video data over the CAN-bus 60 of the traveling cable 16 a high quality of the data transmission may be achieved and any problems associated with the deficiencies of an analogue transmission of audio and video signals are reliably avoided.

FIG. 2 shows an enlarged schematic view of a traveling cable 16 according to an exemplary embodiment of the invention extending between the stationary node 14 and the mobile node 8.

The traveling cable 16 shown in FIG. 2 comprises at least one external power supply line 61 which is connected to a regular power supply 34 for providing electrical power, typically at 48 V, to the elevator car 4.

The traveling cable 16 further comprises a CAN-bus 60 including at least one CAN-bus power supply line 62 and at least one CAN-bus data line 63, which is configured for transmitting digital data between the stationary node 14 and the mobile node 8.

The CAN-bus power supply line 62 is electrically connected by means of a stationary DC/DC-converter 36 to the regular power supply 34 for providing the electrical power which is to be transferred to elevator car 4. The electrical power, which is typically provided by the regular power supply 34 at a voltage of 48 V, is converted by the stationary DC/DC-converter 36 to a reduced voltage of e.g. 12 V and is then supplied to the CAN-bus power supply line 62 in order to deliver the electrical power to the mobile node 8 operating the data transfer between the elevator car 4 and the stationary node 14.

A back-up power supply 32, e.g. comprising a battery, is provided for supplying power to the CAN-bus 60, the mobile node 8, the stationary node 14 and the auto-dialer 18 in case of a breakdown of the regular power supply 34.

A mobile DC/DC-converter 38 is provided at the elevator car 4 allowing to deliver electrical power from the regular power supply 34, which is transferred to the elevator car 4 by means of the external power line 61 of the traveling cable 16 to the mobile node 8 in case of an interruption or short-cut of the CAN-bus power supply line 62 or a breakdown of the stationary DC/DC-converter 36.

There are basically five different types of failure situations:

Situation 1: The Regular Power Supply 34 Breaks Down

In consequence, the elevator system 1 does not run anymore and the passengers are trapped within the elevator car 4. Emergency calls are available due to the back-up power supply 32 of the CAN-bus 60 and vocal communication with the service center 20 over the CAN-bus 60 is possible.

Situation 2: The CAN-Bus Power Line 62 is Interrupted

The elevator system 1 does not run anymore and the passengers are trapped within the elevator car 4. The emergency devices 10, 11, 12 at the elevator car 4 are powered by means of the mobile DC/DC converter 38 converting the power supplied at a voltage of 48 V by the external power line 61 of the traveling cable 16 to a voltage of 12 V for allowing emergency calls and voice communication over the CAN-bus 60.

Situation 3: A CAN-Bus Data Line 63 is Interrupted

The elevator system 1 does not run anymore and the passengers are trapped within the elevator car 4. The emergency devices 10, 11, 12 provided at the elevator car 4 are powered via the CAN-bus power supply line 62. The failure of the CAN-bus data line 63 will be detected automatically without the need of manually triggering an alarm. Instead, an emergency call to the service center 20 is initiated by the auto-dialer 18 and an alarm message is delivered. A voice interface, which is part of the mobile node 8, will issue a pre-defined announcement to potential passengers trapped within the elevator car 4.

Situation 4: The External Phone Line 19 is Interrupted

The elevator system 1 continues to operate; the passengers are not trapped in the elevator car 4. The emergency devices 10, 11, 12 at the elevator car 4 are powered by the CAN-bus power supply line 62. However, voice communication via the phone line 19 is not available. This failure situation will be detected within three days by a call from the service center 20 to the elevator system 1, as it is requested by EN81-28.

Situation 5: The Traveling Cable 16 is Interrupted Completely

The elevator system 1 does not run anymore and the passengers are trapped within the elevator car 4. As all lines 61, 62, 63 of the traveling cable 16 are interrupted or short-cut, no power is supplied to the elevator car 4 and no communication is possible. This failure is detected immediately and an emergency call to the service center is initiated automatically by the auto-dialer 18.

A basic idea is to use the existing CAN-bus 60 connecting the elevator car 4 and in particular the elevator control electronic 30 with the elevator drive 7 for additionally transmitting alarm related data, such as alarm activation, feedback for passengers and in particular voice communication between people (passengers or service personnel) inside or at the elevator car 4 and an external service center 20 or people located within the vicinity of the elevator system 1.

Exemplary embodiments of the invention provide inter alia the following advantages: Simplification of wiring, as less wires in traveling cable 16 are needed when the existing CAN-bus 60 is used for additional functions, in particular the transmission of digital voice data. In combination with the use of safety electronics, the traveling cable 16 may be reduced to the next smaller size, e.g. to a standard cable with twelve wires instead of cable with twenty four wires. In addition, the quality of the transmission is improved, as the analogue transmission is replaced by digital data transmission, which is less sensitive to electromagnetic compatibility (“EMC”) noise. Commercial parts from the cell-phone market, e.g. microphones that directly generate digital data, may be used in order to keep the costs of the system low.

As a result, the invention provides improved data transmission to and from the elevator car 4 allowing vocal and/or visual communication with people situated within or at the elevator car 4 even in emergency situations. A breakdown of at least one of the lines 61, 62, 63 of the traveling cable 16 can be compensated without causing an unsafe situation. In consequence, the invention provides a better failure reaction than the existing state of the art.

### Further Embodiments

A number of optional features are set out in the following. These features may be realized in particular embodiments, alone or in combination with any of the other features:

In an embodiment at least one of the mobile node and the stationary node is connected to a loudspeaker for converting analog sound signals into sound.

In an embodiment at least one of the mobile node and the stationary node is connected to a microphone for converting sound into analog sound signals.

In an embodiment the mobile node and the stationary node respectively comprise at least one analog-to-digital converter and/or digital-to-analog converter configured for converting sound into digital data and/or for converting digital data into sound, respectively. An analog-to-digital converter and a digital-to-analog converter may be provided as separate entities or they may be integrated in a single entity providing an analog-to-digital-and-digital-to-analog converter.

On the transmitter side the voice and/or video data received is converted into digital data that will be compressed by a suited codec. After the compression the data is transmitted via the CAN bus of the traveling cable. On the receiver side the compressed data is decoded and converted into sound and/or video.

In an embodiment the stationary node is connected to an auto-dialer which is configured for connecting the stationary node to an external service center via the telephone network in order to allow vocal communication between people situated within or at the elevator car and an external service center without providing a stationary line connecting the elevator system to the external service center.

The availability and the correct functioning of the alarm systems in the car are monitored by the mobile node provided in or at the car. Regular status messages, which are exchanged over the CAN bus between the control electronic and the car, are used to perform the monitoring function. In case a faulty function of an alarm device on the car is detected, the stationary node activates the auto dialer to send a request for service to the service center.

Both nodes, the mobile node on the car and the stationary node, are part of the alarm system and may be supplied by an existing back-up battery in case of mains power outage.

In an embodiment the CAN-bus comprises at least one data line for transmitting the (digital) data and at least one power line for supplying electrical power to the elevator car. Additional power lines allow the implementation of an autonomous power supply of the CAN-bus, which allows communication between the elevator car and the external world even in case the main power supply has broken down.

In an embodiment at least one of the nodes is configured to issue an alarm message when an alarm button at the elevator car is pressed or when at least one of the data lines and/or of the power lines of the CAN-bus is interrupted or short-cut. This increases the safety of the elevator system as faults of the CAN-bus are immediately detected and can be fixed.

In an embodiment the elevator system comprises at least one external power line, which is separate from the CAN-bus and allows to transfer electrical energy to the elevator car even when the power supply line of the CAN-bus is interrupted or short-cut.

In an embodiment at least one of the nodes is configured to trigger an alarm when the external power line is interrupted or short-cut. This increases the safety of the elevator system even further as faults of the external power line are immediately detected in order to be fixed.

In an embodiment at least one of the power lines is electrically connected to a back-up power supply, in particular a back-up battery, in order to provide electrical power even in case no power is supplied from outside the elevator system, e.g. due to a breakdown of the external electrical network.

The elevator system may comprise a plurality of elevator cars, wherein each elevator car is provided with at least one mobile node in order to allow vocal communication between every elevator car and a common service center comprising a single stationary node, which is connected to all mobile nodes provided at each elevator car by means of a single CAN-bus. Such a configuration allows to keep the costs low, as only a single CAN-bus needs to be implemented.

Alternatively, the system may comprise a plurality of stationary nodes and/or a plurality of CAN-buses in order to increase the safety and reliability of the elevator system by means of redundancy.

### REFERENCES

1 elevator system
2 hoistway
3 tension member
4 elevator car
6 floor
7 elevator drive
8 mobile node
9a mobile analog/digital converter
9b mobile digital/analog converter
10 mobile microphone
11 alarm button
12 mobile loudspeaker
14 stationary node
15a stationary analog/digital converter
15b stationary digital/analog converter
16 traveling cable
18 auto-dialer
19 external network/telephone line
20 service center
22 communication unit
24, 25 stationary loudspeaker
26, 27 stationary microphone
28 emergency light
30 control electronic
32 back-up power supply
34 regular power supply
36 stationary DC/DC converter
38 mobile DC/DC converter
40 video camera
42 video display
60 CAN-bus
61 external power supply line
62 CAN-bus power supply line
63 CAN-bus data line

1. Elevator system (1), comprising:
an elevator car (4), which is moveable along a hoistway (2);
a mobile node (8) moving together with the elevator car (4);
a stationary node (14), which does not move with the elevator car (4); and
a CAN-bus (60) interconnecting the mobile node (8) with the stationary node (14) for transmitting data between the nodes (8, 14);
characterized in that
the mobile node (8) and the stationary node (14) are configured for transmitting sound and/or video data from and/or to the elevator car (4) via the CAN-bus (60).

2. Elevator system (1) of claim 1, wherein the mobile node (8) and the stationary node (14) respectively comprise at least one analog/digital-converter (Sa, 14a), which is configured for converting analog sound signals into digital data and/or for converting digital data into analog sound signals.

3. Elevator system (1) of claim 1, wherein the mobile node (8) and/or the stationary node (14) is connected to a loudspeaker (12, 24, 25) for converting analog sound signals into sound.

4. Elevator system (1) of claim 1, wherein the mobile node (8) and/or the stationary node (14) is connected to a microphone (10, 26, 27) for converting sound into analog sound signals.

5. Elevator system (1) of claim 1, wherein the stationary node (14) is connected to an auto-dialer (18), which is configured for establishing a connection between the stationary node (14) and an external communication unit (22), in particular a communication unit (22) located in a service center (20).

6. Elevator system (1) of claim 1, wherein the CAN-bus (60) comprises at least one data line (63) for transmitting data signals and at least one power supply line (62) for supplying electrical power to the elevator car (4).

7. Elevator system (1) of claim 6, wherein at least one of the nodes (8, 14) is configured to issue an alarm message when an alarm button (11) is pressed or at least one data line (63) and/or at least one power supply line (62) of the CAN-bus (60) is interrupted or short-cut.

8. Elevator system (1) of claim 1, wherein the elevator system (1) comprises an external power supply line (61) for supplying power to the elevator car (4) independently of the CAN-bus (60).

9. Elevator system (1) of claim 8, wherein at least one of the nodes (8, 14) is configured to issue an alarm message when the external power supply line (61) is interrupted or short-cut.

10. Elevator system (1) of claim 6, wherein at least one of the power supply lines (61, 62) is connected to a back-up power supply (32), in particular a back-up battery.

11. Elevator system (1) of claim 1 comprising a plurality of elevator cars (4), wherein each elevator car (4) is provided with at least one mobile node (8).

12. Elevator system (1) of claim 11 comprising a single stationary node (14), which is connected to the plurality of mobile nodes (8) via a single CAN-bus (60).

13. Elevator system (1) of claim 11 comprising a plurality of stationary nodes (14), which are connected to the plurality of mobile nodes (8) via a single CAN-bus (60).

14. Elevator system (1) of claim 11 comprising a plurality of stationary nodes (14) and a plurality of CAN-buses (60), wherein each of the CAN-buses (60) connects one of the stationary nodes (14) to at least one mobile node (8).

15. Method of transmitting sound and/or video from and/or to an elevator car (4) comprising:
converting the sound and/or video data into digital data;
transmitting the digital data via a CAN-bus (60) from and/or to the elevator car (4);
converting the digital data into sound and/or video.
